(19) United States
(12) Patent Application Publication
(10) Pub. No.: US 2007/0053026 A1
(43) Pub. Date: Mar. 8, 2007

(54) Image filing apparatus, image filing method and storage medium

(76) Inventors: Yoshiyuki Fukuya, Sagamihara-shi (JP); Tetsu Morita, Fuchu-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/515,456

(22) Filed: Aug. 31, 2006

(30) Foreign Application Priority Data
Sep. 2, 2005 (JP) 2005-254751
Jul. 24, 2006 (JP) 2006-201122

(51) Int. Cl. G06K 15/00

(52) U.S. Cl. 358/527; 358/1.18

(57) ABSTRACT

An information filing method of an information filing apparatus equipped with a display, the method includes storing information and attribute information associated with the information, classifying a plurality of pieces of the information into a plurality of classification units on the basis of the attribute information, displaying a list of classification units in a first area of the display, selecting the classification unit displayed in the first area, displaying, in a second area of the display, an index of the information classified into the classification unit, selecting one classification unit or a plurality of consecutive classification units displayed in the first area, and classifying the classification unit into more detailed classification units and displaying the more detailed classification units in the first area.

### CROSS-REFERENCE TO RELATED APPLICATIONS

This application is based upon and claims the benefit of priority from prior Japanese Patent Applications No. 2005-254751, filed Sep. 2, 2005; and No. 2006-201122, filed Jul. 24, 2006, the entire contents of both of which are incorporated herein by reference.

### BACKGROUND OF THE INVENTION

1. Field of the Invention

The present invention relates to an information filing apparatus, an information filing method and a storage medium capable of flexibly narrowing down categories in a simple and easy operation and easily obtaining predetermined information.

2. Description of the Related Art

A method that enables retrieval with good operability is desired when predetermined information is retrieved.

For example, a technique disclosed in Jpn. Pat. Appln. KOKAI Publication No. 11-215457 is known as a method of simply retrieving a captured image. In this method, a reduced image of the captured image is displayed in a calendar for each period (year, month, date). Then, if a user specifies a date and points a desired reduced image displayed in the calendar, the corresponding captured image is reproduced and displayed.

### BRIEF SUMMARY OF THE INVENTION

A first aspect of the present invention is directed to an information filing apparatus comprising:

a display; an information storing section which stores information and attribute information associated with the information; an information classifying section which classifies a plurality of pieces of information stored in the information storing section into a plurality of classification units on the basis of the attribute information; a first classification unit display section which displays a list of classification units in a first area of the display; a first classification unit selecting section which selects the classification unit displayed in the first area; an index display section which displays, in a second area of the display, an index of the information classified into the classification unit selected in the first classification unit selecting section; a second classification unit selecting section which selects one classification unit or a plurality of consecutive classification units displayed in the first area; and a second classification unit display section which classifies the classification unit selected in the second classification unit selecting section into more detailed classification units and displays the more detailed classification units in the first area.

A second aspect of the present invention is directed to an information filing method of an information filing apparatus equipped with a display, the method comprising: an information storing step of storing information and attribute information associated with the information; an information classifying step of classifying a plurality of pieces of information stored in the information storing step into a plurality of classification units on the basis of the attribute information; a first classification unit display step of displaying a list of classification units in a first area of the display; a first classification unit selecting step of selecting the classification unit displayed in the first area; an index display step of displaying, in a second area of the display, an index of the information classified into the classification unit selected in the first classification unit selecting step; a second classification unit selecting step of selecting one classification unit or a plurality of consecutive classification units displayed in the first area; and a second classification unit display step of classifying the classification unit selected in the second classification unit selecting step into more detailed classification units and displaying the more detailed classification units in the first area.

A third aspect of the present invention is directed to a storage medium storing an information filing program to be executed by an information filing apparatus equipped with a display, the program comprising: an information storing step of storing information and attribute information associated with the information; an information classifying step of classifying a plurality of pieces of information stored in the information storing step into a plurality of classification units on the basis of the attribute information; a first classification unit display step of displaying a list of classification units in a first area of the display; a first classification unit selecting step of selecting the classification unit displayed in the first area; an index display step of displaying, in a second area of the display, an index of the information classified into the classification unit selected in the first classification unit selecting step; a second classification unit selecting step of selecting one classification unit or a plurality of consecutive classification units displayed in the first area; and a second classification unit display step of classifying the classification unit selected in the second classification unit selecting step into more detailed classification units and displaying the more detailed classification units in the first area.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the configuration of an information filing screen;

FIG. 2 is a diagram explaining a function of selecting a category;

FIG. 3 is a diagram explaining a function of switching the display of a category display area;

FIG. 4 is a diagram explaining display update associated with a size change of the information filing screen;

FIG. 5 is a diagram explaining a function of changing displayed categories;

FIG. 6 is a diagram explaining a selection operation by linear display;

FIG. 7 is a diagram explaining a selection operation by the linear display;

FIG. 8 is a diagram showing a category display setting dialogue;

FIG. 9 is a diagram showing the configuration of an information filing apparatus;

FIG. 10 is a flowchart showing main processing of information filing processing;

FIG. 11 is a flowchart showing load processing;

FIG. 12 is a diagram showing the contents of a management DB;

FIG. 13 is a flowchart showing update processing of the category display area;

FIG. 14 is a diagram showing category display increasing processing;

FIG. 15 is a flowchart showing display adjustment processing;

FIG. 16 is a flowchart showing window resize processing;

FIG. 17 is a flowchart showing category display decreasing processing;

FIG. 18 is a flowchart showing thumbnail display processing;

FIG. 19 is a flowchart showing category display setting processing;

FIG. 20 is a flowchart showing category display returning processing;

FIG. 21 is a diagram showing timeline display; and

FIG. 22 is a diagram explaining the rearrangement of the categories.

### DETAILED DESCRIPTION OF THE INVENTION

In an information filing method according to an embodiment of the present invention, a user executes an information filing operation on the basis of an information filing screen displayed on a display unit of an information filing apparatus. It is to be noted that a case in which an image is dealt with as information will be described in the following embodiment.

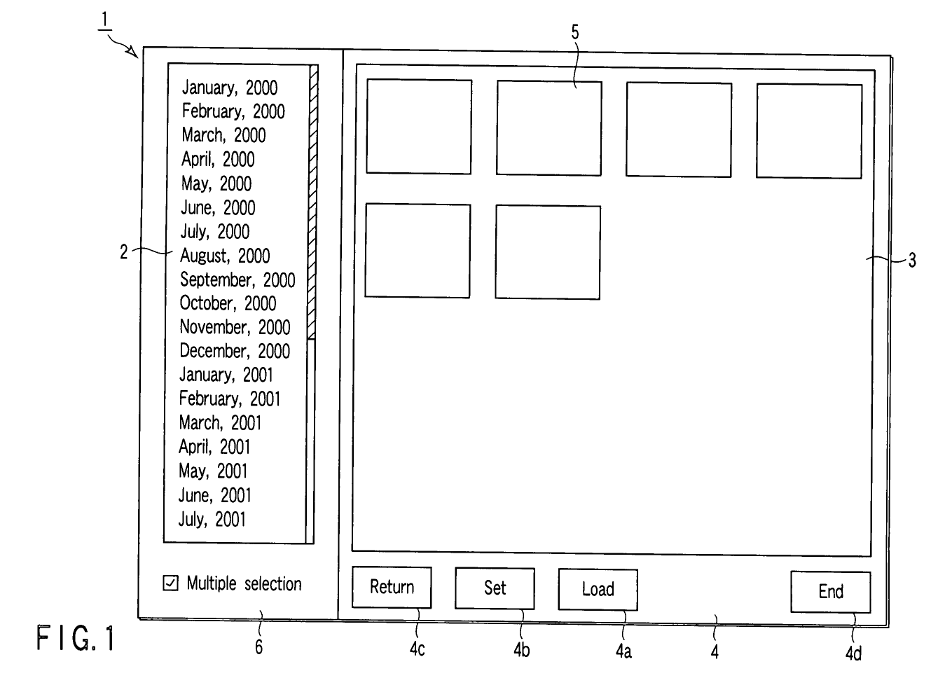

FIG. 1 is a diagram showing the configuration of the information filing screen according to the information filing method in a first embodiment of the present invention.

An information filing screen 1 is provided with a category display area 2, a thumbnail display area 3, an operation button display area 4 and a multiple selection setting check box 6.

Furthermore, the operation button display area 4 is provided with a load button 4a, a setting button 4b, a return button 4c and an end button 4d.

Categories as classification units such as year, month and date are displayed in the category display area 2. Thumbnail images 5 of images belonging to the selected category are displayed in the thumbnail display area 3.

The multiple selection setting check box 6 specifies the operation when a category to be displayed in the category display area 2 is selected. If the check box is turned on, it is possible to select a plurality of inconsecutive categories, and moreover, when a category is selected, the thumbnail images 5 of images belonging to the selected category are displayed. If the check box is turned off, categories belonging to a layer lower than that of a selected category are displayed in the category display area 2 when the category is selected.

When the load button 4a is operated, an image can be loaded into the information filing apparatus. When the setting button 4b is operated, it is possible to specify a method of displaying the categories or the like. When the return button 4c is operated, it is possible to return the display state of the categories to the preceding display state. When the end button 4d is operated, information filing processing is terminated.

In addition, a mode is called linear display in which the categories are sorted and displayed in an ordered and listed manner in the category display area 2 as shown in FIG. 1.

It is to be noted that the kinds of categories displayed in the category display area 2 are not limited to year, month and date. In the embodiment according to the present invention, anything can be employed as a category as long as it has a hierarchical structure. For example, it is possible to use areas (country→district→prefecture→city→town . . . ) and dates (year→month→part→week→day . . . ) as categories.

Furthermore, the size of the category display area 2 can be preset. In the present embodiment, the size of the category display area 2 can be set on the basis of the size of the category display area 2 displayed in the information filing screen 1 which is the main window.

The contents of details of this will be fully described later.

Next, the main functions of the information filing processing will be described.

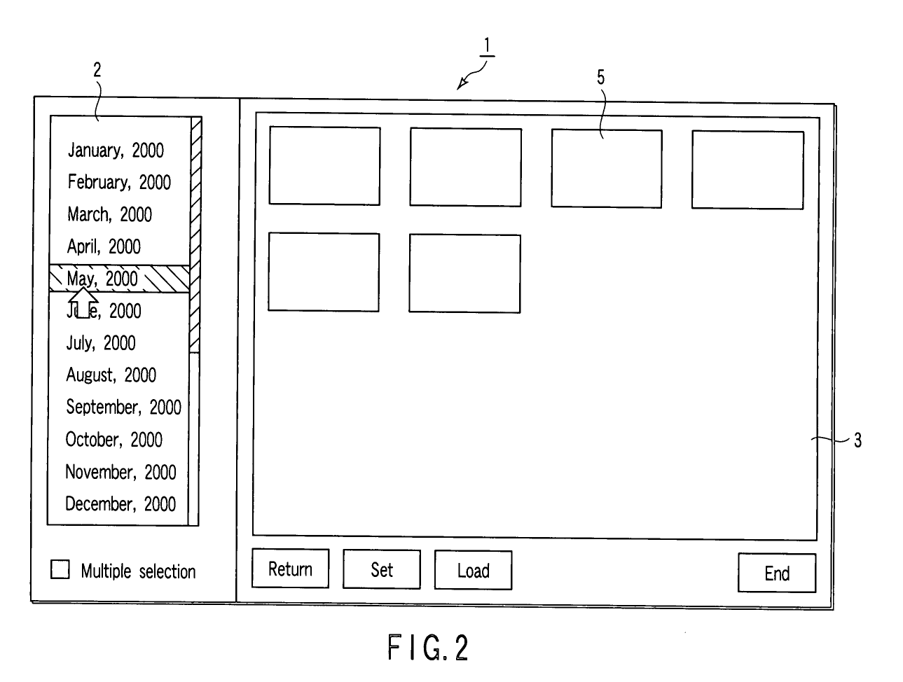

FIG. 2 is a diagram explaining a function of selecting a category.

When the user clicks and specifies an arbitrary category from the categories displayed in the category display area 2, or when the user turns on the multiple selection setting check box 6 and selects a plurality of categories, the thumbnail images 5 of images belonging to the specified or selected category are retrieved and displayed in the thumbnail display area 3.

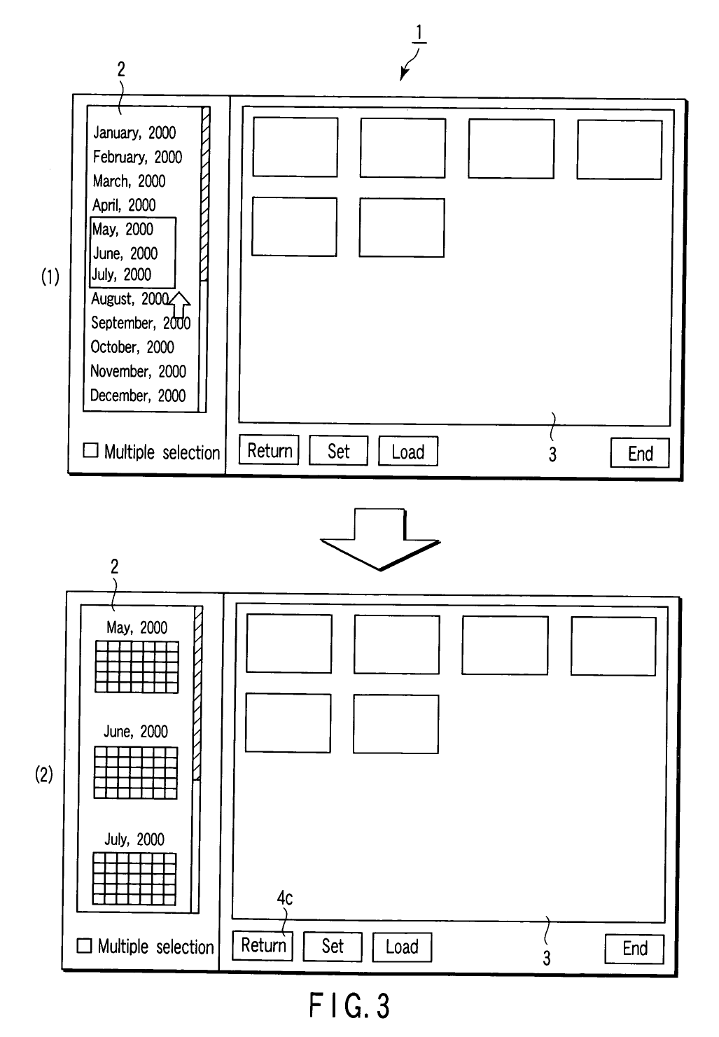

FIG. 3 is a diagram explaining a function of switching the display of the category display area 2.

The user selects a category such that categories more detailed than the category displayed in the category display area 2, that is, categories belonging to a lower layer can be displayed.

The user selects one or more categories from the categories displayed in the category display area 2. In (1) of FIG. 3, May to July, 2000 are selected by a drag operation. Then, as shown in (2) of FIG. 3, categories are displayed in a calendar form for May to July, 2000 so that a date can be selected.

It is to be noted that such a mode of displaying the categories in a calendar form is called calendar display.

Furthermore, even by this operation, the thumbnail image 5 displayed in the thumbnail display area 3 remains unchanged. The above-mentioned operation is only effective in the category display in the category display area 2. Therefore, the user again clicks and specifies a category, such that the thumbnail image 5 in the thumbnail display area 3 is updated and displayed.

It is to be noted that when one or more selected categories are to be displayed in the calendar form including lower categories by the above-mentioned operation, the categories are displayed up to a lower layer that can be displayed if the size to be displayed is larger than the preset size of the category display area 2.

For example, when May to July, 2000 are selected, lower categories that can be displayed in the preset category display area 2 are displayed among the categories belonging to the lower categories such as “part”, “week” and “date”.

On the other hand, when the size to be displayed is smaller than the preset size of the category display area 2, still lower categories are displayed by the above-mentioned operation. For example, when morning, afternoon, evening, midnight, etc. which are the lower categories of “date” can be displayed, the display is switched so that these categories can be displayed. That is, as long as the size of the category display area 2 allows, lower categories can be displayed.

Furthermore, the user presses the return button 4c, such that the operation for the detailed display can be canceled to return to the preceding state.

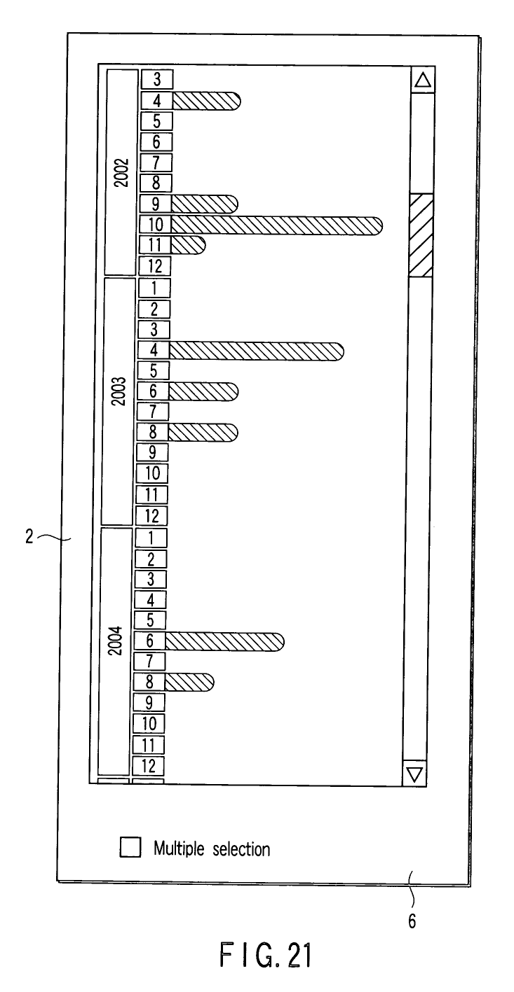

It is to be noted that the display in the category display area 2 can be switched to timeline display as shown in FIG. 21. The timeline display is one kind of linear display, in which together with the categories such as year, month and date, the number of images included in these categories is indicated in a bar graph.

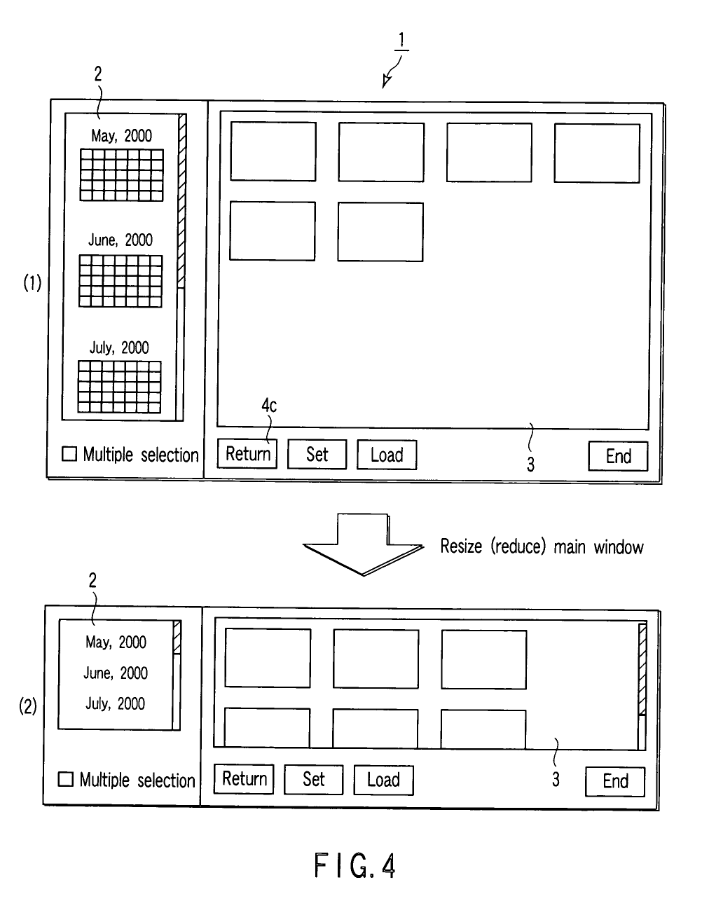

FIG. 4 is a diagram explaining display update associated with a size change of the information filing screen 1.

If the size of the information filing screen 1 is changed, the size of the category display area 2 is also changed, and the contents of the displayed categories are changed in accordance with the changed size.

When the size of the information filing screen 1 shown in (1) of FIG. 4 is reduced as shown in (2) of FIG. 4, the size of the category display area 2 is also reduced. As a result, in (2) of FIG. 4, the display of the lower categories is omitted, and “months” are displayed which are upper categories that can be displayed.

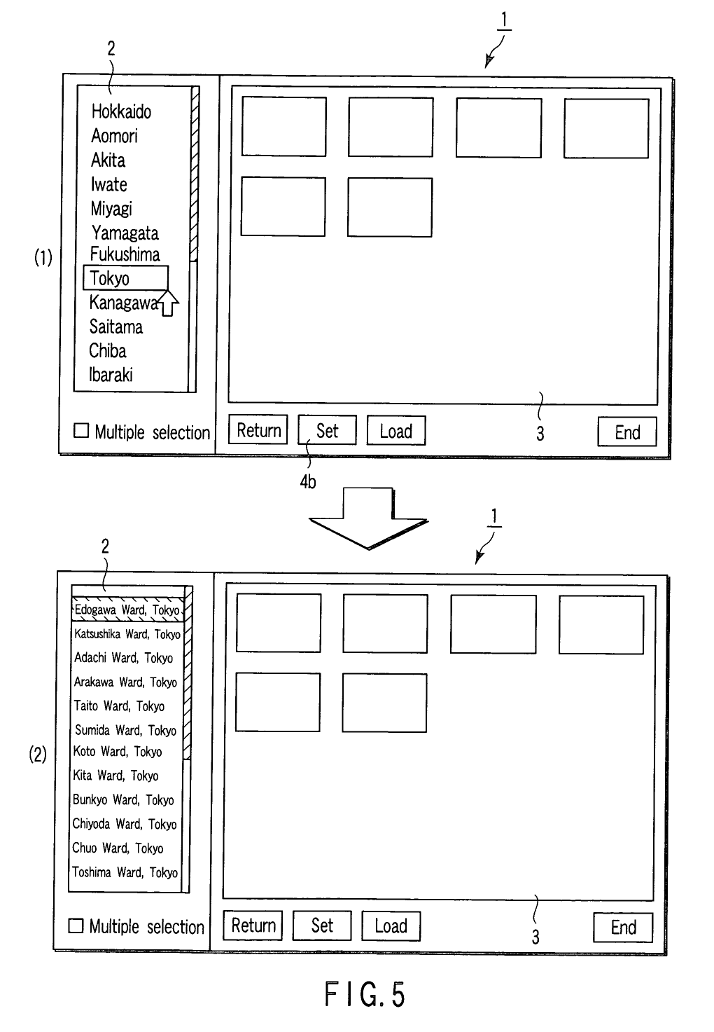

FIG. 5 is a diagram explaining a function of changing displayed categories.

The user can operate the setting button 4b to change the kind of category to be displayed. It is to be noted that the function of the setting button 4b will be described later.

When the user operates the setting button 4b to change the category from “year, month and date” to “area”, place names are displayed in the category display area 2, as shown in (1) of FIG. 5. The user clicks the category of a place name such that the thumbnail images 5 of images belonging to that category can be displayed. For example, when “Tokyo” is clicked, the thumbnail images 5 belonging to “Tokyo” are displayed in the thumbnail display area 3.

Next, the user selects one or more categories from the categories displayed in the category display area 2. For example, when the category “Tokyo” is selected, categories lower than the selected “Tokyo”, that is, categories indicating “wards” are displayed, as shown in (2) of FIG. 5. Then, if the user clicks “Edogawa Ward, Tokyo” the thumbnail images 5 of images belonging to Edogawa Ward, Tokyo can be displayed.

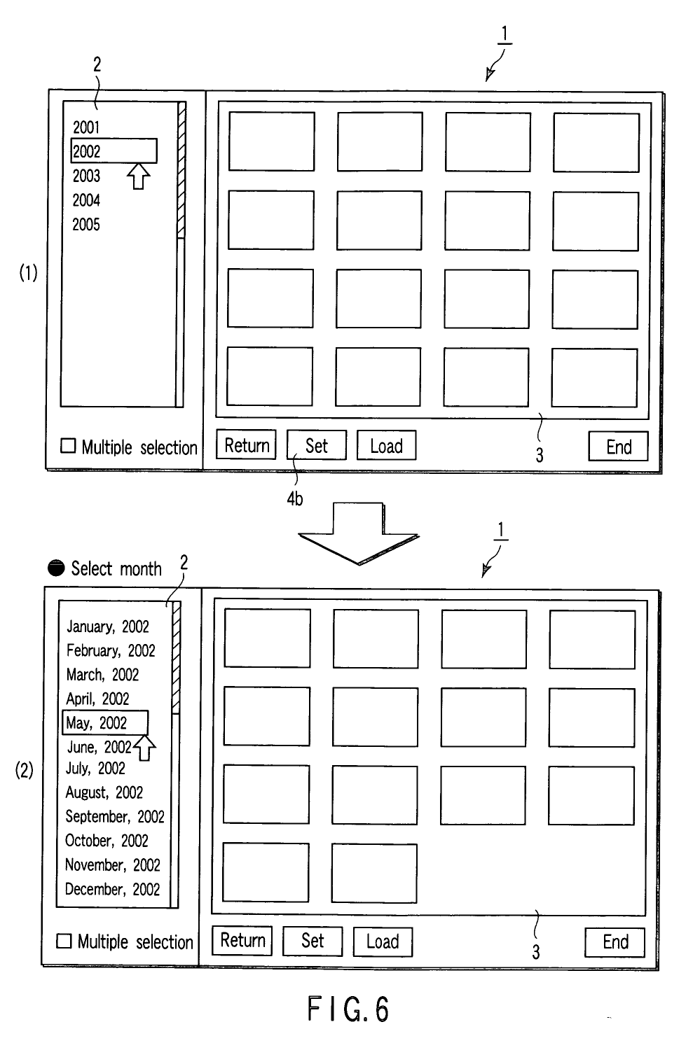

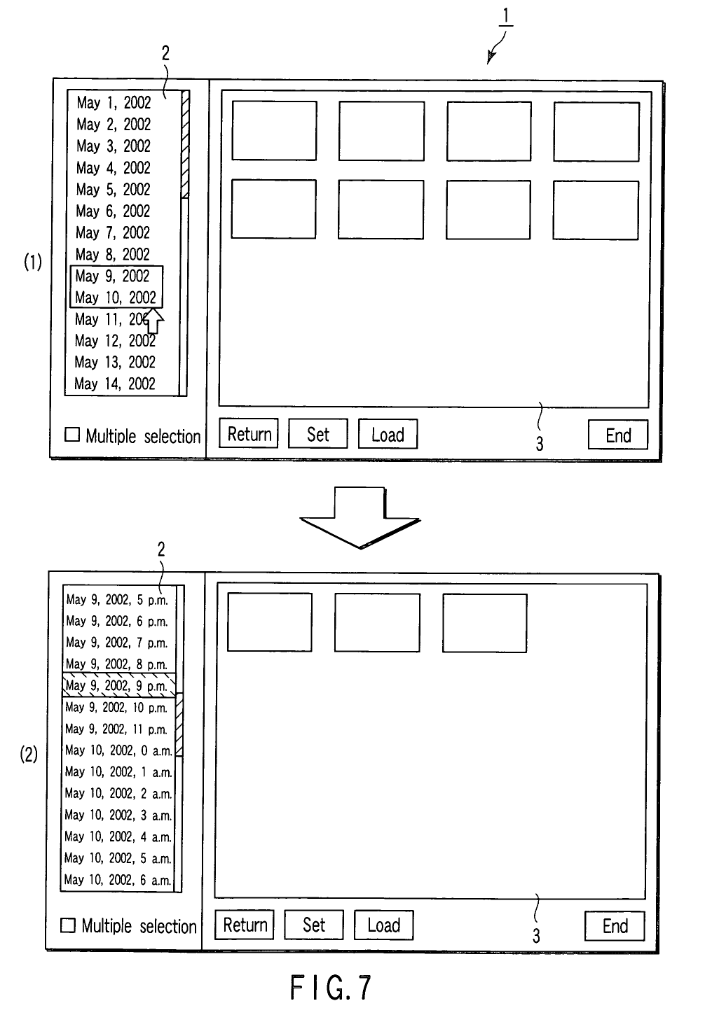

FIGS. 6 and 7 are diagrams explaining a selection operation by the linear display.

The user can operate the setting button 4b to change the calendar display in the category display area 2 to the linear display. It is to be noted that the function of the setting button 4b will be described later.

When the user selects, for example, the year 2002 from the categories displayed in the category display area 2 in (1) of FIG. 6, categories lower than the selected year 2002, that is, categories indicating “months” are displayed, as shown in (2) of FIG. 6.

Then, when the user selects, for example, May, 2002 from the categories displayed in the category display area 2 in (2) of FIG. 6, categories lower than the selected May, 2002, that is, categories indicating “dates” are displayed, as shown in (1) of FIG. 7. It is to be noted that May 15, 2002 and dates thereafter are displayed by scrolling.

When the user selects, for example, May 9 and 10, 2002 from the categories displayed in the category display area 2 as shown in (1) of FIG. 7, categories lower than selected May 9 and 10, 2002, that is, categories indicating “times” are displayed, as shown in (2) of FIG. 7. It is to be noted that “times” that are not displayed can be displayed by operating a scroll bar.

Next, the function of the setting button 4b will be described.

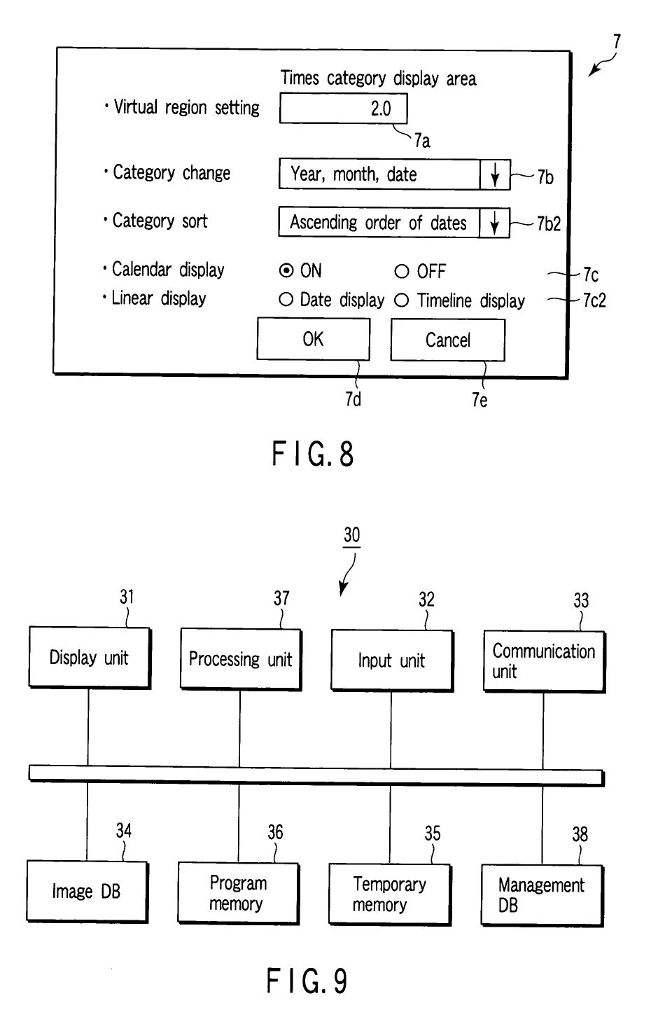

When the user operates the setting button 4b, a category display setting dialogue 7 shown in FIG. 8 is displayed.

In the category display setting dialogue 7, there are provided a virtual region setting section 7a, a category changing section 7b, a category sorting section 7b2, a calendar display radio button 7c, a linear display radio button 7c2, an OK button 7d and a cancel button 7e.

In the virtual region setting section 7a, the size of an area that can be displayed by scrolling in the category display is specified. If “2.0” is set in the virtual region setting section 7a, a size twice as large as the size of the currently displayed category display area 2 is set as a new size of the category display area 2. Therefore, up to this size, the categories can be displayed, and the categories that could not be displayed in one screen can be displayed by operating the scroll bar.

In the category changing section 7b, the kind of category to be displayed in the category display area 2, for example, “year, month and date”, “area” or the like can be set. The user causes a pull-down menu of the category changing section 7b to be displayed to select “year, month and date”, “area” or the like.

A sorting method can further be selected from the category sorting section 7b2 in accordance with the selection by the category changing section 7b. That is, the order of arranging the categories to be displayed in the category display area 2 can be set for the category set in the category changing section 7b.

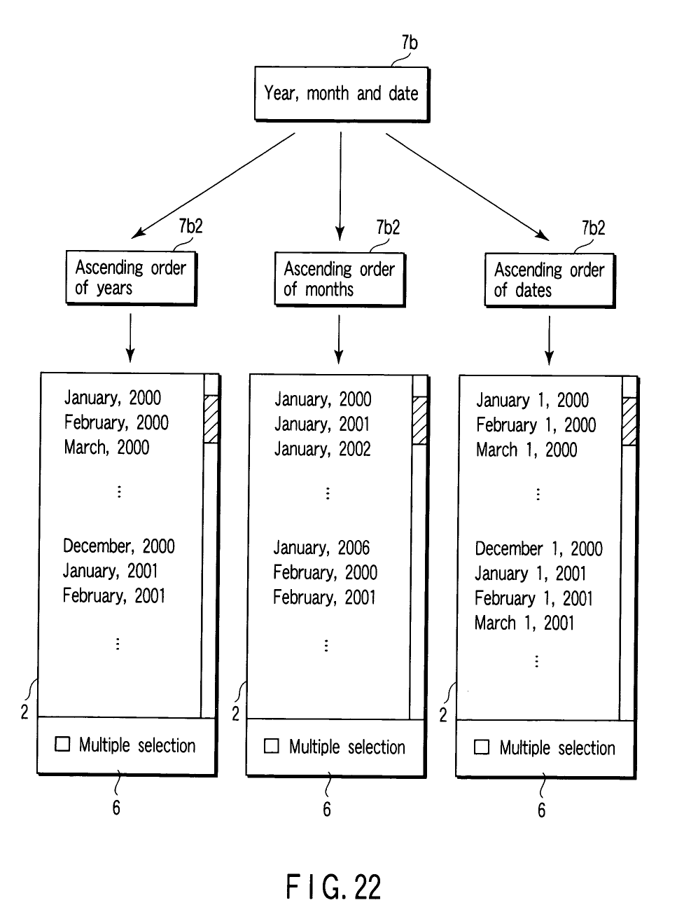

FIG. 22 is a diagram explaining the rearrangement of the categories.

When “year, month and date” is selected in the category changing section 7b, it is possible to select, from the category sorting section 7b2, “ascending order of years”, “descending order of years”, “ascending order of months”, “descending order of months”, “ascending order of dates”, “descending order of dates”, etc.

When “ascending order of years” is selected, sorting is performed so that increments are produced with first priority to year, as in “January, 2000”, “February, 2000”, . . . , “January, 2001”, “February, 2001”, . . . .

When “ascending order of months” is selected, sorting is performed so that increments are produced with first priority to month, as in “January, 2000”, “January, 2001”, “January, 2002”, . . . , “February, 2000”, “February, 2001”, . . . . Thus, a particular month in each year can be sequentially selected.

When “ascending order of dates” is selected, sorting is performed so that increments are produced with first priority to date, as in “Jan. 1, 2000”, “Feb. 1, 2000”, “Mar. 1, 2000”, . . . , “Jan. 1, 2001”, “Feb. 1, 2001”, “Mar. 1, 2001”, . . . . Thus, a particular date in each month of the year can be sequentially selected.

It is to be noted that when the area is selected in the category changing section 7b, it is possible to select, from the category sorting section 7b2, “ascending order of area names”, “descending order of area names”, “ascending order of latitudes”, “descending order of latitudes”, “ascending order of longitudes”, “descending order of longitudes”, “ascending order of distances”, “descending order of distances”, etc. “distances” can be indicated as distances from a particular area, for example, Tokyo.

When the category is displayed in year, month and date, it is possible to select, by the category display setting dialogue 7 shown in FIG. 8, whether the display of dates is to be indicated in the calendar form or in the linear display without using the calendar.

If “ON” in the calendar display radio button 7c is selected, the display of dates can be indicated in the calendar form.

If “OFF” in the calendar display radio button 7c is selected, the linear display radio button 7c2 is operable. From the linear display radio button 7c2, it is possible to select date display or timeline display as the display type in the category display area 2. It is to be noted that in the linear display, a minimum unit that can be displayed can be hour and minute, in contrast with the calendar display.

When the OK button 7d is pressed, the contents of settings described above are reflected in the category display area 2. When the cancel button 7e is pressed, the current state continues without reflecting the setting contents.

Next, the configuration of the information filing apparatus for achieving the information filing method described above and a procedure of its main processing will be described.

FIG. 9 is a diagram showing the configuration of an information filing apparatus 30. The information filing apparatus 30 comprises a display unit 31, an input unit 32, a communication unit 33, an image DB 34, a temporary memory 35, a program memory 36, a processing unit 37 and a management DB 38.

The display unit 31 is a CRT or a TFT liquid crystal display for displaying the information filing screen 1. The input unit 32 is an input device such as a keyboard, mouse or the like for receiving an operational instruction input from the user. The communication unit 33 is an interface for exchanging information such as image files with an external device (not shown) such as a digital camera by communication. The image DB 34 is a storage medium for storing image data.

The temporary memory 35 is a buffer memory for temporarily storing information necessary for the processing of filing information such as setting history data. The program memory 36 stores a program for controlling functions of the information filing apparatus 30. The processing unit 37 universally controls the operation of the information filing apparatus 30. The management DB 38 stores management information such as category hierarchy necessary for the information filing processing.

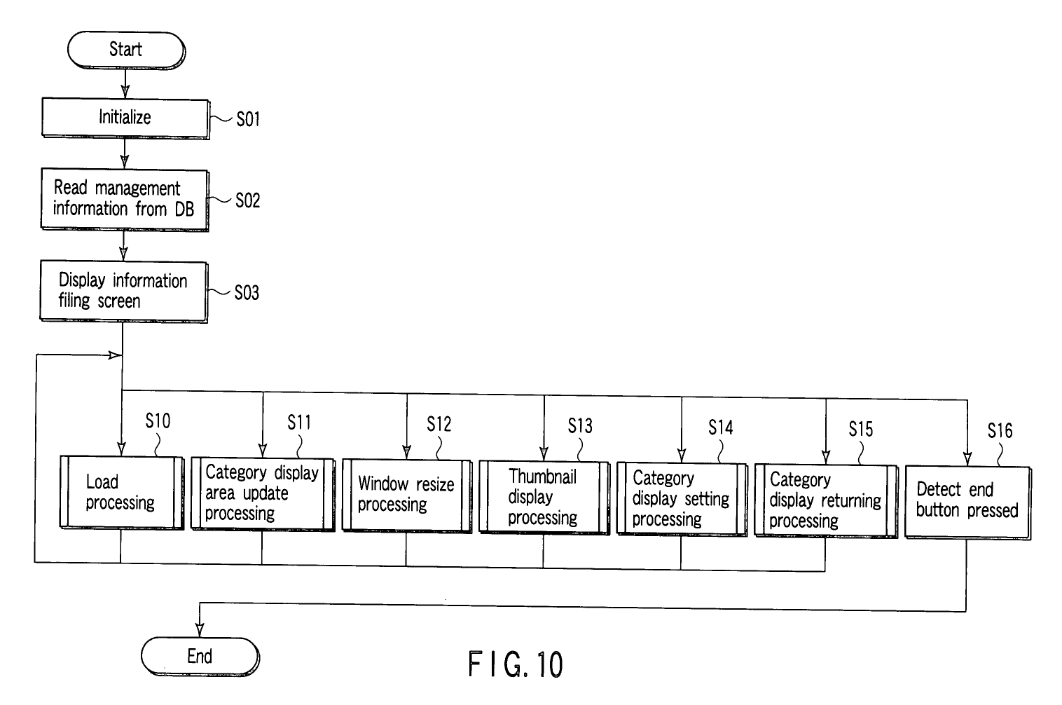

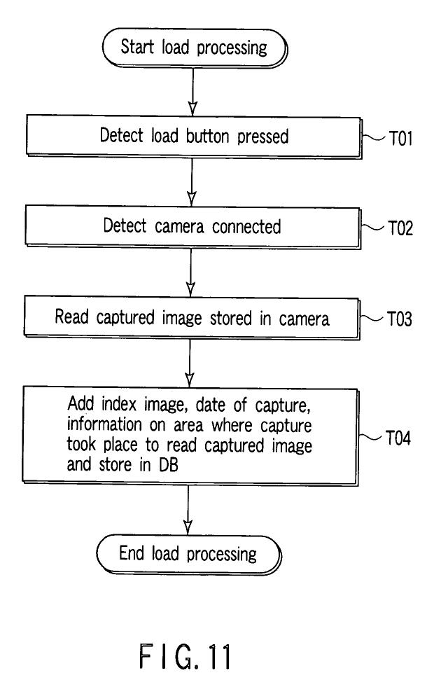

Next, a schematic procedure of the information filing processing will be described referring to FIGS. 10 to 20. It is to be noted that the processing described below is processing concerning the main functions among the information filing processing functions. Therefore, the functions described in the explanation with FIGS. 1 to 9 are included in the present information filing processing functions even if these functions are not described in the following explanation.

FIG. 10 is a flowchart showing the main processing of the information filing processing.

When the user starts the information filing screen 1, the processing unit 37 initializes files and the like in step S01 in FIG. 10, and reads the management information per image from the management DB 38 in step S02. In step S03, the information filing screen 1 is displayed in accordance with the contents set in the step of initialization and the management information. Then, the processing unit 37 waits for the next operation of the user.

When the user connects a camera (not shown) to the information filing apparatus 30 and operates the load button 4a, load processing shown in step S10 (FIG. 11) is started.

When the processing unit 37 detects in steps T01 and T02 in FIG. 11 that the load button 4a has been pressed and that the camera is connected, a captured image saved in the camera is read in step T03.

Then, in step T04, an index image, date of capture and information on the area where the image was captured are added to the read captured image and saved in the management DB 38 in step T04.

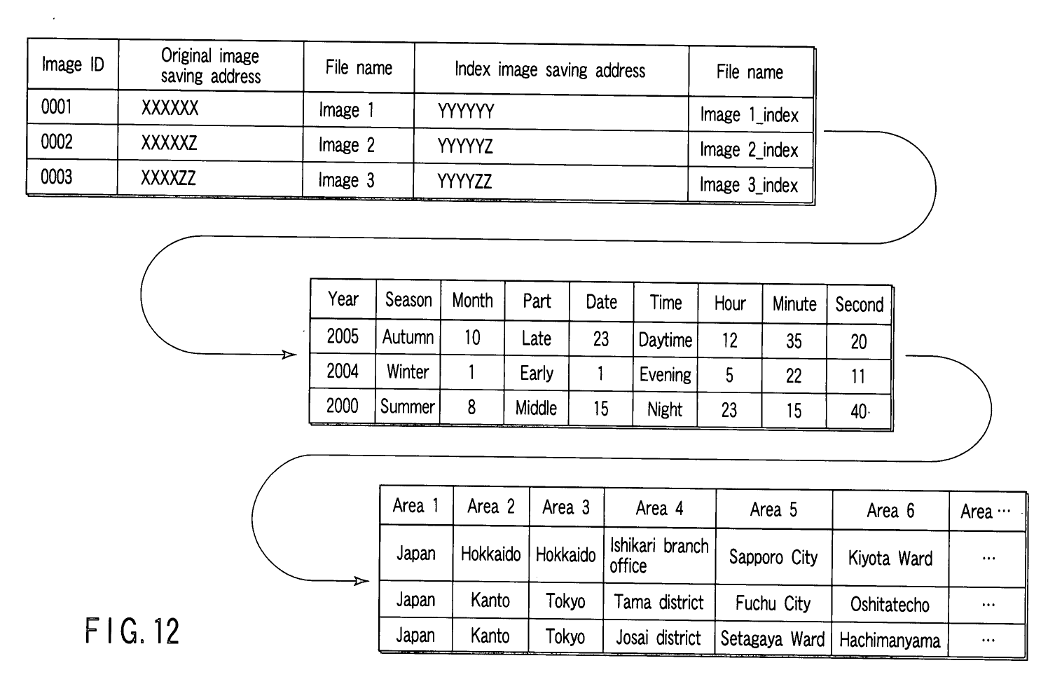

FIG. 12 is a diagram showing the contents of the management DB 38.

An “image ID” is provided for each read captured image (original image). Then, the place where the original image is saved is stored in an “original image saving address”, and the place where a reduced image of the original image is saved is stored in an “index image saving address”. It is to be noted that the original image and the index image are saved in the image DB 34.

Furthermore, data are hierarchically written for each original image in “year”, “season”, “month”, “part”, “date”, “time”, “minute” and “second” which are categories concerning “year, month and date”. Moreover, hierarchized data are written in the categories concerning “area”.

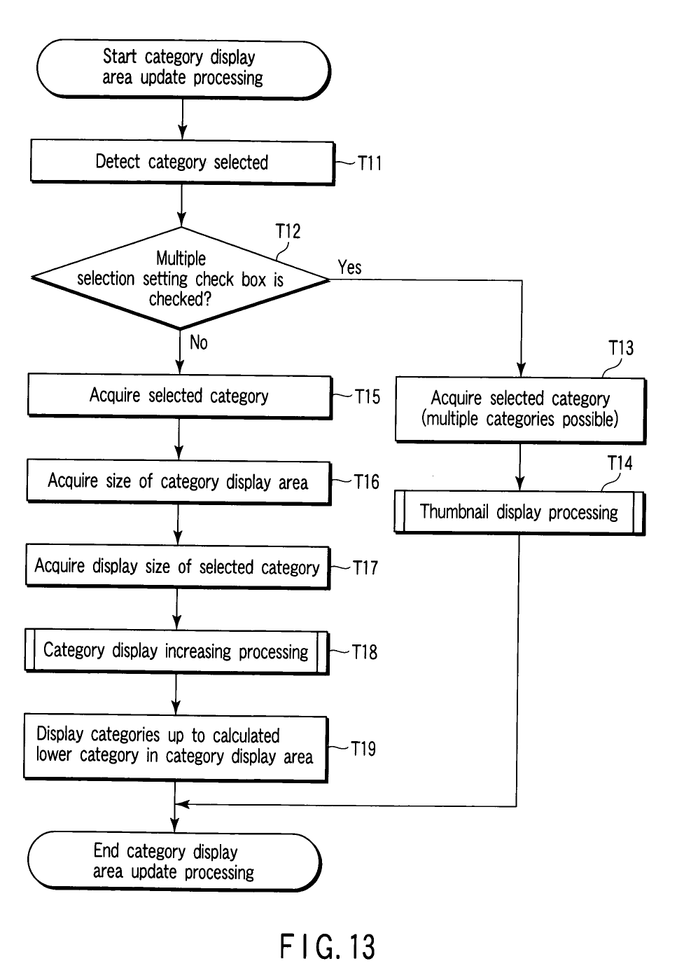

Returning to FIG. 10, when the user selects a category by, for example, the drag operation in the category display area 2 of the information filing screen 1, processing of updating the category display area shown in step S11 (FIG. 13) is started.

When the processing unit 37 detects in step T11 in FIG. 13 that a category is selected, the processing unit 37 checks in step T12 whether the multiple selection setting check box 6 is checked.

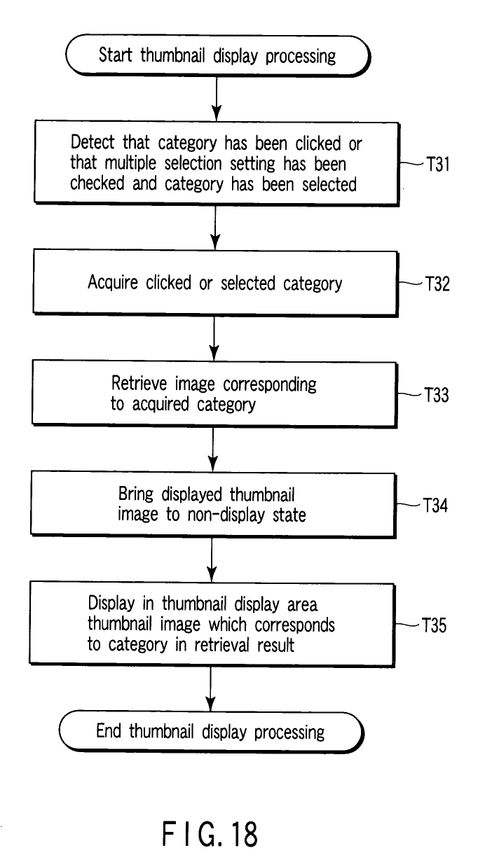

When the result is Yes in step T12, that is, when the multiple selection setting check box 6 is checked, the selected category is acquired in step T13. Then, thumbnail display processing shown in step T14 (FIG. 18) is started, and the thumbnail images of images belonging to the selected category are displayed. It is to be noted that details of the thumbnail display processing (FIG. 18) will be described later.

When the result is No in step T12, that is, when the multiple selection setting check box 6 is not checked, the selected category is acquired in step T15. Then, the size of the set category display area 2 is acquired in step T16, and a display size is acquired for the selected category in step T17.

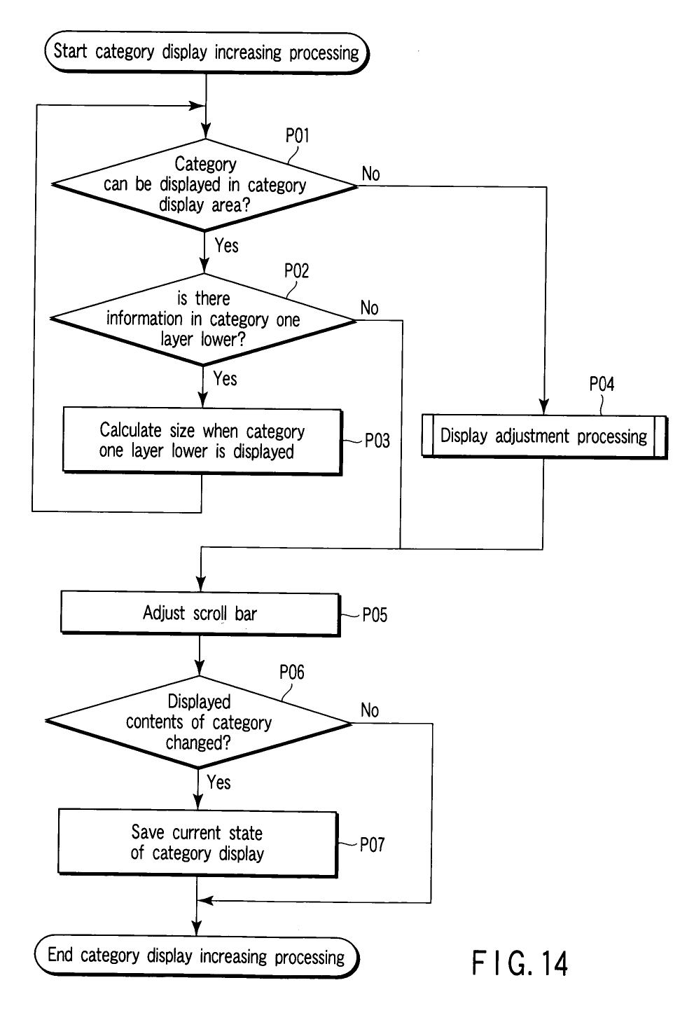

Then, category display increasing processing shown in step T18 (FIG. 14) is started.

In step P01 in FIG. 14, a check is made to find out whether the selected category can be displayed in the category display area 2. When the result is Yes in step P01, that is, when the size of the selected category is smaller than the size of the category display area 2, a check is made in step P02 to find out whether there is information in a category one layer lower than the selected category.

When the result is No in step P02, that is, when there is no information in the category one layer lower than the selected category, a move is made to step P05 to perform display processing.

On the other hand, when the result is Yes in step P02, that is, when there is information in the category one layer lower than the selected category, a display size when the category one layer lower is displayed is calculated in step P03. Then, the processing in and after step P01 is repeated.

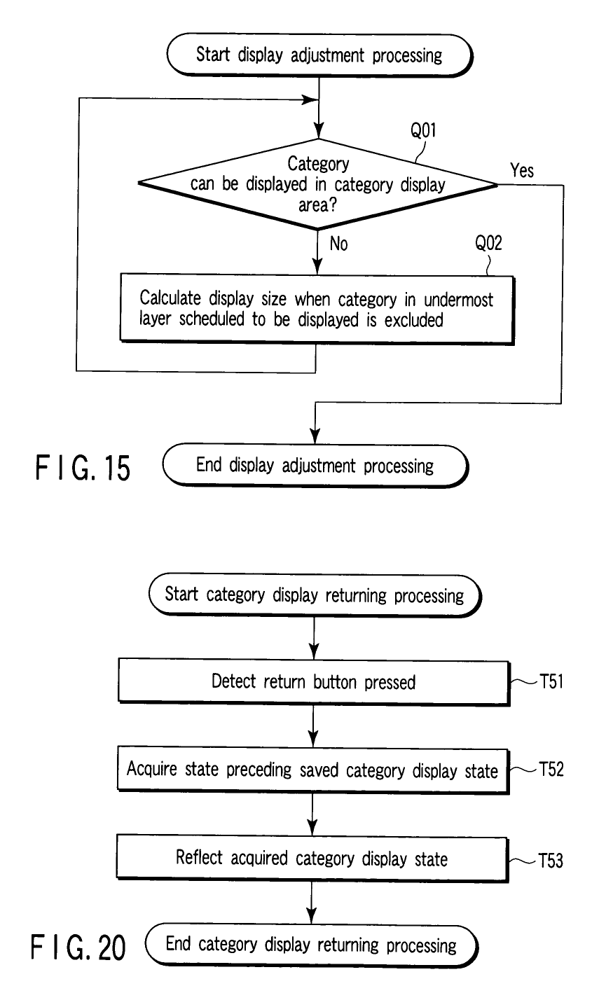

When the result is No in step P01, that is, when the display size of the category is larger than the size of the category display area 2, the categories in this layer can not be displayed, and display adjustment processing shown in step P04 (FIG. 15) is therefore started.

In step Q02 in FIG. 15, a display size when the category in the undermost layer scheduled to be displayed is excluded is calculated and set as a new display size. Then, in step Q01, a check is made to find out whether the category of the new display size can be displayed in the category display area 2. This processing is repeated until the category of the new display size can be displayed in the category display area 2.

Returning to FIG. 14, the category display area 2 for displaying the category is arranged in step P05. If a virtual region is needed, the scroll bar is displayed.

In step P06, a check is made to find out whether the displayed contents of the category are changed from what they were. When the result is Yes in step P06, that is, when the contents to be displayed in the category display area 2 are changed, the current state of the category display is saved as history information in the temporary memory 35 in step P07.

When the result is No in step P06, that is, when the contents to be displayed in the category display area 2 are not changed, the present processing is terminated without writing history information.

Returning to FIG. 13, in step T19, the categories up to the calculated lower category are displayed in the category display area 2, and processing of updating the category display area is terminated.

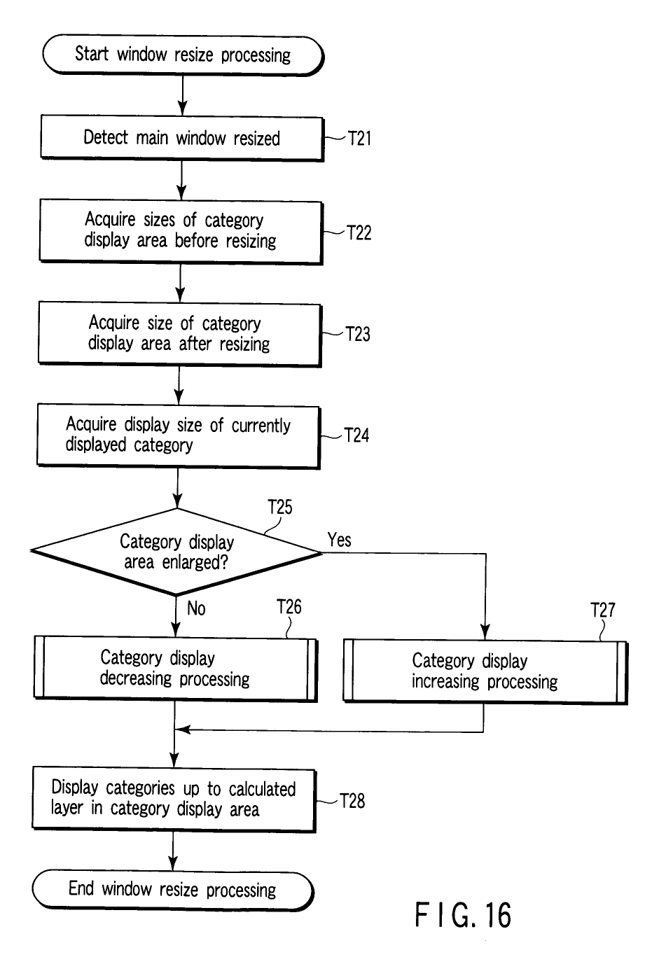

Returning to FIG. 10, when the user changes (resizes) the size of the information filing screen 1 by, for example, the drag operation, window resizing processing shown in step S12 (FIG. 16) is started.

When the processing unit 37 detects in step T21 in FIG. 16 that the main window has been resized, the processing unit 37 acquires the sizes of the category display area 2 before and after the resizing in steps T22 and T23. Then, in step T24, the display size of the currently displayed category is acquired.

In step T25, a check is made to find out whether the category display area 2 has been enlarged by the resizing.

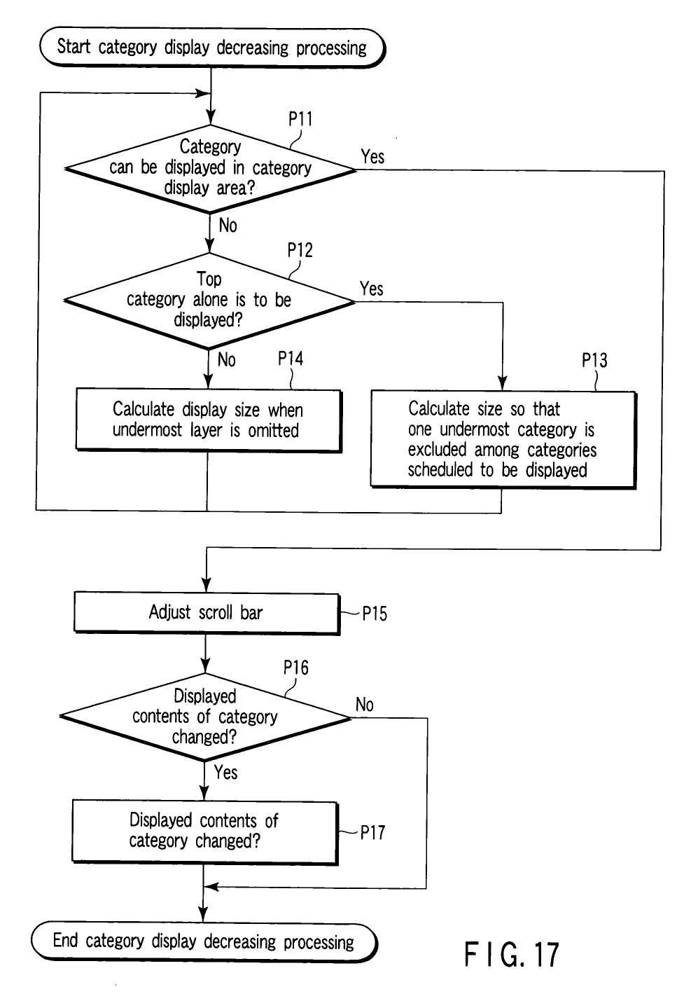

When the result is No in step T25, that is, when the category display area 2 has been reduced by the resizing, category display decreasing processing shown in step T26 (FIG. 17) is started.

In step P12 in FIG. 17, a check is made to find out whether what is displayed is the top category.

When the result is Yes in step P12, that is, when what is displayed is the top category, a size is calculated in step P13 so that one undermost category is excluded among the categories scheduled to be displayed, thereby setting new displayed categories and returning to step P11.

When the result is No in step P12, that is, when the displayed category includes the lower categories, a display size when the undermost category is omitted is calculated in step P14, thereby setting this display size as a new display size and returning to step P11.

In step P11, a check is made to find out whether this display size can be displayed in the category display area 2.

When the result is No in step P11, that is, when the display size of the category is larger than the size of the category display area 2, the category in this layer can not be displayed, and processing in and after step P12 is therefore repeated.

When the result is Yes in step P11, that is, when the display size of the category is smaller than the size of the category display area 2, the categories in this layer can be displayed, the category display area 2 for displaying the categories is arranged in step P15. If a virtual region is needed, the scroll bar is displayed.

In step P16, a check is made to find out whether the displayed contents of the category are changed from what they were. When the result is Yes in step P16, that is, when the contents to be displayed in the category display area 2 are changed, the current state of the category display is saved as history information in the temporary memory 35 in step P17.

When the result is No in step P16, that is, when the contents to be displayed in the category display area 2 are not changed, the present processing is terminated without writing history information.

Returning to FIG. 16, when the result is Yes in step P25, that is, when the category display area 2 has been enlarged by the resizing, the category display increasing processing shown in step T27 (FIG. 14) is started. It is to be noted that the category display increasing processing has already been explained and not explained again.

Then, in step T28, the categories up to the calculated layer are displayed in the category display area 2, and the resize processing is terminated.

Returning to FIG. 10, when the user clicks and specifies a category in the category display area 2 of the information filing screen 1, the thumbnail display processing shown in step S13 (FIG. 18) is started. It is to be noted that the thumbnail display processing (FIG. 18) is also started by executing step T14 in FIG. 13.

When the processing unit 37 detects in step T31 in FIG. 18 that a category has been clicked or that the multiple selection setting check box 6 has been checked and a category has been selected, the clicked or selected category is acquired in step T32. Then, in step T33, the images belonging to the acquired category are retrieved.

In steps T34 and T35, the displayed thumbnail image 5 is brought to a non-display state, and the thumbnail image 5 of the retrieved image is displayed in the thumbnail display area 3, thus terminating the present processing.

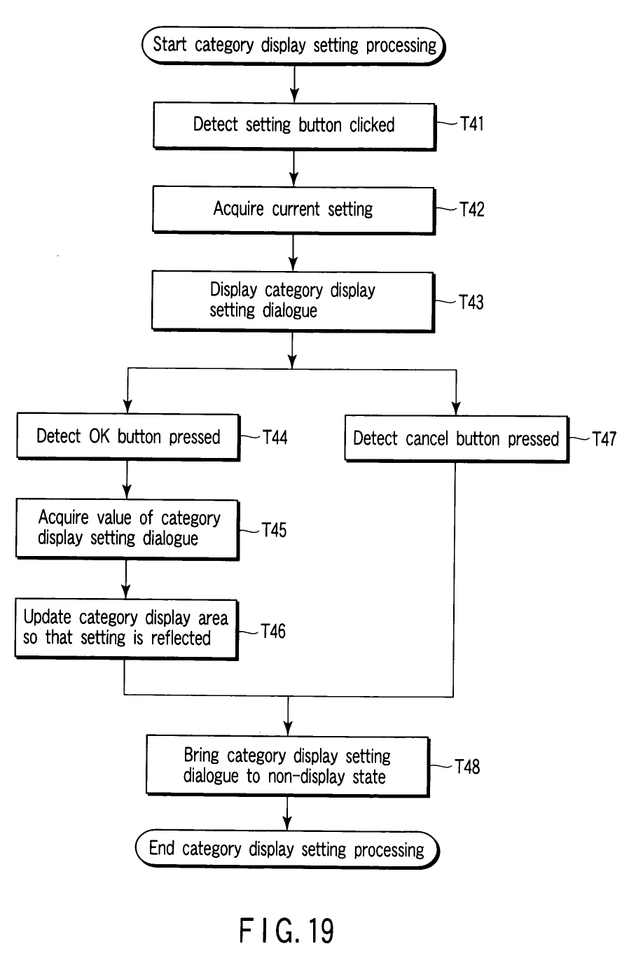

Returning to FIG. 10, when the user operates the setting button 4b in the operation button display area 4 of the information filing screen 1, category display setting processing shown in step S14 (FIG. 19) is started.

When the processing unit 37 detects in step T41 in FIG. 19 that the setting button 4b has been clicked, the processing unit 37 acquires the current setting state in step T42. Then, in step T43, the category display setting dialogue 7 shown in FIG. 8 is displayed, thus waiting for a setting operation of the user.

When the user operates the OK button 7d of the category display setting dialogue 7, the processing unit 37 detects in step T44 that the OK button 7d has been operated, and the processing unit 37 acquires in step T45 a value set in the category display setting dialogue 7. Then, in step T46, the display of the category display area 2 is updated on the basis of the set value.

That is, the size of the new category display area 2 is updated in accordance with the data in the virtual region setting section 7a. The order of displaying the categories is changed in accordance with the data in the category changing section 7b and the category sorting section 7b2.

When the calendar display radio button 7c is ON, the calendar is displayed in the display of dates. When the calendar display radio button 7c is OFF, the state of the linear display radio button 7c2 is checked to find out whether it is ON or OFF. When a date display radio button is ON, a list of dates is displayed in the category display area 2. When a timeline display radio button is ON, a list of dates is displayed together with a graph in the category display area 2.

When the user operates the cancel button 7e, the processing unit 37 does not update the display in step T47.

Then, in step T48, the category display setting dialogue 7 is brought to a non-display state, thereby terminating the category display setting processing.

Returning to FIG. 10, when the user operates the return button 4c in the operation button display area 4 of the information filing screen 1, category display returning processing shown in step S15 (FIG. 20) is started.

When the processing unit 37 detects in step T51 in FIG. 20 that the return button 4c has been clicked, the processing unit 37, in step T52, retrieves in the temporary memory 35 and acquires a state preceding the saved category display state. Then, the acquired category display state is reflected in the information filing screen 1, thus terminating the category display returning processing.

Returning to FIG. 10, when the user operates the end button 4d in the operation button display area 4 of the information filing screen 1, the information filing processing is terminated.

In the information filing method according to the embodiment described above, when the range of categories is selected in the category display area 2, the thumbnail images 5 of images included in the selected categories can be displayed, and categories in the lower layers can be displayed as far as the category display area 2 can display.

Thus, the user can efficiently acquire desired information.

Furthermore, the size of the category display area can also be changed to adjust the layers of the categories to be displayed.

Still further, the order of displaying the categories can be changed to a desired order such as “ascending order of years” or “ascending order of months”.

Further yet, a variety of display modes can be selected by the operation of the user, such as the calendar display and the linear display (date display, timeline display).

Therefore, it is possible to flexibly adapt to a condition in which the operation is easy for the user.

It is to be noted that the embodiment described above deals with the case of retrieving an image, but a sound, a picture or text may also be retrieved. Then, the category can be year, month and date (time) when or an area (place) where such information has been acquired or generated. Thus, in general, the present invention can be widely applied to any information as long as such information permits a category to be classified into more detailed categories, for example, as long as such information can be classified by a hierarchical structure.

It is to be noted that the functions described in the above embodiment may be configured by use of hardware or may be achieved by using software and reading into a computer a program in which these functions are written. Moreover, either software or hardware may be properly selected to configure the functions.

Furthermore, the functions can also be achieved by reading into a computer a program stored in an unshown storage medium. Here, the storage medium in the present embodiment may be in any recording mode as long as it is capable of recording a program and is a computer-readable storage medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An information filing apparatus comprising:
a display;
an information storing section which stores information and attribute information associated with the information;
an information classifying section which classifies a plurality of pieces of information stored in the information storing section into a plurality of classification units on the basis of the attribute information;
a first classification unit display section which displays a list of classification units in a first area of the display;
a first classification unit selecting section which selects the classification unit displayed in the first area;
an index display section which displays, in a second area of the display, an index of the information classified into the classification unit selected in the first classification unit selecting section;
a second classification unit selecting section which selects one classification unit or a plurality of consecutive classification units displayed in the first area; and
a second classification unit display section which classifies the classification unit selected in the second classification unit selecting section into more detailed classification units and displays the more detailed classification units in the first area.

2. The information filing apparatus according to claim 1, wherein
the classification unit has a hierarchical structure; and
the second classification unit display section displays classification units belonging to a layer lower than that of the classification unit selected in the second classification unit selecting section.

3. The information filing apparatus according to claim 2, wherein
a physical or virtual size of the first area displayed on the second classification unit display section is equal to a physical or virtual size of the first area displayed on the first classification unit display section; and
the second classification unit display section selects a lower layer being within a range which does not exceed the physical or virtual size of the first area, and displays the classification units included in the layer.

4. The information filing apparatus according to claim 3, wherein
the attribute information is information on a time or a place at which the above information is acquired or generated.

5. The information filing apparatus according to claim 4, wherein
the information is image information or audio information.

6. The information filing apparatus according to claim 3, further comprising:
a sort selecting section which selects the kind of sort, and a sort section which orders the plurality of classification units in accordance with the kind of sort selected in the sort selecting section; and
wherein the second classification unit display section displays a list of classification units in the first area of the display on the basis of the above order.

7. The information filing apparatus according to claim 1, comprising
an information amount display section which displays the amount of information included in each classification unit in the first area together with the classification unit.

8. An information filing method of an information filing apparatus equipped with a display, the method comprising:
an information storing step of storing information and attribute information associated with the information;
an information classifying step of classifying a plurality of pieces of information stored in the information storing step into a plurality of classification units on the basis of the attribute information;
a first classification unit display step of displaying a list of classification units in a first area of the display;
a first classification unit selecting step of selecting the classification unit displayed in the first area;
an index display step of displaying, in a second area of the display, an index of the information classified into the classification unit selected in the first classification unit selecting step;
a second classification unit selecting step of selecting one classification unit or a plurality of consecutive classification units displayed in the first area; and
a second classification unit display step of classifying the classification unit selected in the second classification unit selecting step into more detailed classification units and displaying the more detailed classification units in the first area.

9. The information filing method according to claim 8, wherein
the classification unit has a hierarchical structure; and
the second classification unit display step comprises displaying classification units belonging to a layer lower than that of the classification unit selected in the second classification unit selecting step.

10. The information filing method according to claim 9, wherein
a physical or virtual size of the first area displayed in the second classification unit display step is equal to a physical or virtual size of the first area displayed in the first classification unit display step; and
the second classification unit display step comprises selecting a lower layer being within a range which does not exceed the physical or virtual size of the first area, and displaying the classification units included in the layer.

11. The information filing method according to claim 10, wherein
the attribute information is information on a time or a place at which the above information is acquired or generated.

12. The information filing method according to claim 11, wherein
the information is image information or audio information.

13. The information filing method according to claim 10, further comprising:
a sort selecting step of selecting the kind of sort; and
a sort step of ordering the plurality of classification units in accordance with the kind of sort selected in the sort selecting step,
wherein the second classification unit display step comprises displaying a list of classification units in the first area of the display on the basis of the above order.

14. The information filing method according to claim 8, comprising
an information amount display step of displaying the amount of information included in each classification unit in the first area together with the classification unit.

15. A storage medium storing an information filing program to be executed by an information filing apparatus equipped with a display, the program comprising:
an information storing step of storing information and attribute information associated with the information;
an information classifying step of classifying a plurality of pieces of information stored in the information storing step into a plurality of classification units on the basis of the attribute information;
a first classification unit display step of displaying a list of classification units in a first area of the display;
a first classification unit selecting step of selecting the classification unit displayed in the first area;
an index display step of displaying, in a second area of the display, an index of the information classified into the classification unit selected in the first classification unit selecting step;
a second classification unit selecting step of selecting one classification unit or a plurality of consecutive classification units displayed in the first area; and
a second classification unit display step of classifying the classification unit selected in the second classification unit selecting step into more detailed classification units and displaying the more detailed classification units in the first area.

16. The storage medium according to claim 15, wherein
the classification unit has a hierarchical structure; and
the second classification unit display step comprises displaying classification units belonging to a layer lower than that of the classification unit selected in the second classification unit selecting step.

17. The storage medium according to claim 15, wherein
a physical or virtual size of the first area displayed in the second classification unit display step is equal to a physical or virtual size of the first area displayed in the first classification unit display step; and
the second classification unit display step comprises selecting a lower layer being within a range which does not exceed the physical or virtual size of the first area, and displaying the classification units included in the layer.

18. The storage medium according to claim 17, wherein
the attribute information is information on a time or a place at which the above information is acquired or generated.

19. The storage medium according to claim 16, the program further comprising:
a sort selecting step of selecting the kind of sort; and
a sort step of ordering the plurality of classification units in accordance with the kind of sort selected in the sort selecting step,
wherein the second classification unit display step comprises displaying a list of classification units in the first area of the display on the basis of the above order.

20. The storage medium according to claim 15, the program further comprising:
an information amount display step of displaying the amount of information included in each classification unit in the first area together with the classification unit.
